(19) United States
(12) Patent Application Publication
(10) Pub. No.: US 2014/0204121 A1
(43) Pub. Date: Jul. 24, 2014

(54) AUGMENTED REALITY FOR OILFIELD

(71) Applicant: SCHLUMBERGER TECHNOLOGY CORPORATION, Sugar Land, TX (US)

(72) Inventors: Stephen Whitley, Katy, TX (US); Floyd Louis Broussard, III, The Woodlands, TX (US); Scott Raphael, Houston, TX (US); Patrick Daniel Dineen, Katy, TX (US); Horacio Ricardo Bouzas, Oslo (NO); Cyril Laroche-Py, Houston, TX (US); Chad Brockman, Cypress, TX (US); Vignesh Venkataraman, Houston, TX (US); Brandon David Plost, Houston, TX (US)

(73) Assignee: SCHLUMBERGER TECHNOLOGY CORPORATION, Sugar Land, TX (US)

(21) Appl. No.: 14/136,793

(22) Filed: Dec. 20, 2013

Related U.S. Application Data
(60) Provisional application No. 61/746,446, filed on Dec. 27, 2012.

(51) Int. Cl. G06T 19/00

(52) U.S. Cl. CPC G06T 19/006
USPC 345/633

(57) ABSTRACT

A method for augmenting an immediate user task includes obtaining role information identifying a role of a user within an oilfield company. The user is performing oilfield operations in a field. The method further includes identifying a current location of the user in the field to identify the immediate user task being performed by the user in the field, defining, using the role information, a user perspective of the user, selecting metadata corresponding to the user perspective to obtain selected metadata, and presenting the selected metadata to the user.

### CROSS-REFERENCE TO RELATED APPLICATIONS

This application claims benefit under 35 U.S.C. §119(e) of U.S. Provisional Patent Application No. 61/746,446, filed on Dec. 27, 2012, and entitled “Augmented Reality For Oilfield”, which is hereby incorporated by reference.

### BACKGROUND

In the oil and gas industry, daily operations include real world tasks that occur in the field, such as drilling and production of hydrocarbons. Real-time augmented reality comes at the intersection of real world tasks and technology. Technology advances at an amazingly fast rate nowadays, allowing technology to enter traditionally manual realms. One such realm is vision itself. In other words, how we as people view the world.

### SUMMARY

In general, in one aspect, embodiments relate to a method for augmenting an immediate user task. The method includes obtaining role information identifying a role of a user within an oilfield company. The user is performing oilfield operations in a field. The method further includes identifying a current location of the user in the field to identify the immediate user task being performed by the user in the field, defining, using the role information, a user perspective of the user, selecting metadata corresponding to the user perspective to obtain selected metadata, and presenting the selected metadata to the user.

Other aspects will be apparent from the following detailed description and the appended claims.

### BRIEF DESCRIPTION OF DRAWINGS

FIGS. 1-6 show schematic diagrams in accordance with one or more embodiments.

FIGS. 7.1 and 7.2 show a flowchart in accordance to one or more embodiments.

FIGS. 8.1, 8.2, 8.3, 9.1, 9.2, and 9.3 show examples in accordance with one or more embodiments.

FIG. 10 shows a computing system in accordance with one or more embodiments.

### DETAILED DESCRIPTION

Specific embodiments will now be described in detail with reference to the accompanying figures. Like elements in the various figures are denoted by like reference numerals for consistency.

In the following detailed description of embodiments, numerous specific details are set forth in order to provide a more thorough understanding. However, it will be apparent to one of ordinary skill in the art that embodiments may be practiced without these specific details. In other instances, well-known features have not been described in detail to avoid unnecessarily complicating the description.

In general, embodiments provide a method and system for augmenting an immediate first user task of a user in a field. Specifically, embodiments identify a role of a user to define a user perspective. The current location of the user and the role are then used to identify the immediate user task of the user. Metadata is selected based on the user perspective on the immediate user task. In one or more embodiments, the selected metadata is presented to the user.

For the purposes of this application, a user task is “immediate” if the user is performing the user task on the field while the user is located at the field. In other words, an immediate task is a task in which the user is currently performing or at least will start performing within the next hour.

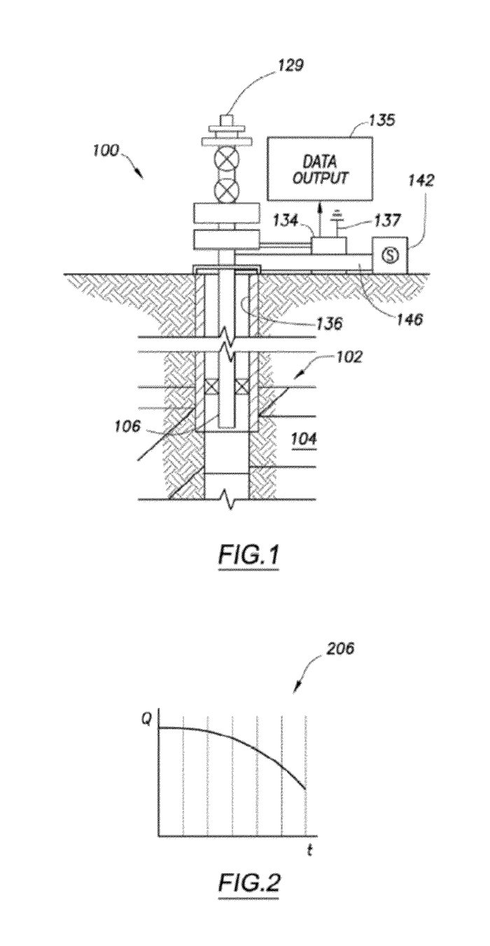

FIG. 1 depicts a simplified, representative, schematic view of a field (100) having subterranean formation (102) having reservoir (104) therein and depicting a production operation being performed on the field (100). More specifically, FIG. 1 depicts a production operation being performed by a production tool (106) deployed from a production unit or christmas tree (129) and into a completed wellbore (136) for drawing fluid from the downhole reservoirs into the surface facilities (142). Fluid flows from reservoir (104) through perforations in the casing (not shown) and into the production tool (106) in the wellbore (136) and to the surface facilities (142) via a gathering network (146).

Sensors (S), such as gauges, may be positioned about the field to collect data relating to various field operations as described previously The data gathered by the sensors (S) may be collected by the surface unit (134) and/or other data collection sources for analysis or other processing. The data collected by the sensors (S) may be used alone or in combination with other data. Further, the data outputs from the various sensors (S) positioned about the field may be processed for use. The data may be collected in one or more databases and/or transmitted on or offsite. The data or select portions of the data may be selectively used for analyzing and/or predicting operations of the immediate and/or other wellbores. The data may be may be historical data, real time data or combinations thereof. The real time data may be used in real time, or stored for later use. The data may also be combined with historical data or other inputs for further analysis. The data may be stored in separate data repositories, or combined into a single data repository.

The collected data may be used to perform analysis, such as modeling operations. For instance, seismic data output may be used to perform geological, geophysical, and/or reservoir engineering. The reservoir, wellbore, surface and/or process data may be used to perform reservoir, wellbore, geological, geophysical or other simulations. The data outputs from the operation may be generated directly from the sensors (S), or after some preprocessing or modeling. These data outputs may act as inputs for further analysis.

The data is collected and stored at the surface unit (134). One or more surface units (134) may be located at the field (100), or connected remotely thereto. The surface unit (134) may be a single unit, or a complex network of units used to perform the data management functions throughout the field (100). The surface unit (134) may be a manual or automatic system. The surface unit (134) may be operated and/or adjusted by a user.

The surface unit (134) may be provided with a transceiver (137) to allow communications between the surface unit (134) and various portions of the field (100) or other locations. The surface unit (134) may also be provided with or functionally connected to one or more controllers for actuating mechanisms at the field (100). The surface unit (134) may then send command signals to the field (100) in response to data received. The surface unit (134) may receive commands via the transceiver or may itself execute commands to the controller. A processor may be provided to analyze the data (locally or remotely) and make the decisions and/or actuate the controller. In this manner, the field (100) may be selectively adjusted based on the data collected. This technique may be used to optimize portions of the operation, such as controlling wellhead pressure, choke size or other operating parameters. These adjustments may be made automatically based on computer protocol, and/or manually by an operator. In some cases, well plans may be adjusted to select optimum operating conditions, or to avoid problems.

As shown, the sensor (S) may be positioned in the production tool (106) or associated equipment, such as the christmas tree, gathering network, surface facilities and/or the production facility, to measure fluid parameters, such as fluid composition, flow rates, pressures, temperatures, and/or other parameters of the production operation.

While FIG. 1 depicts tools used to measure properties of a field (100), it will be appreciated that the tools may be used in connection with non-wellsite operations, such as mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configuration in FIG. 1 is intended to provide a brief description of a field usable for improving production by actual loss allocation. Part, or all, of the field (100) may be on land, sea and/or water. Production may also include injection wells (not shown) for added recovery. One or more gathering facilities may be operatively connected to one or more of the wellsites for selectively collecting downhole fluids from the wellsite(s). Also, while a single field measured at a single location is depicted, improving production by actual loss allocation may be utilized with any combination of one or more fields (100), one or more processing facilities and one or more wellsites.

FIG. 2 is a graphical depiction of data collected by the tools of FIG. 1. FIG. 2 depicts a production decline curve or graph (206) of fluid flowing through the subterranean formation of FIG. 1 measured at the surface facilities (142). The production decline curve (206) provides the production rate (Q) as a function of time (t).

The respective graphs of FIG. 2 depict static measurements that may describe information about the physical characteristics of the formation and reservoirs contained therein. These measurements may be analyzed to better define the properties of the formation(s) and/or determine the accuracy of the measurements and/or for checking for errors. The plots of each of the respective measurements may be aligned and scaled for comparison and verification of the properties.

FIG. 2 depicts a dynamic measurement of the fluid properties through the wellbore. As the fluid flows through the wellbore, measurements are taken of fluid properties, such as flow rates, pressures, composition, etc. As described below, the static and dynamic measurements may be analyzed and used to generate models of the subterranean formation to determine characteristics thereof. Similar measurements may also be used to measure changes in formation aspects over time.

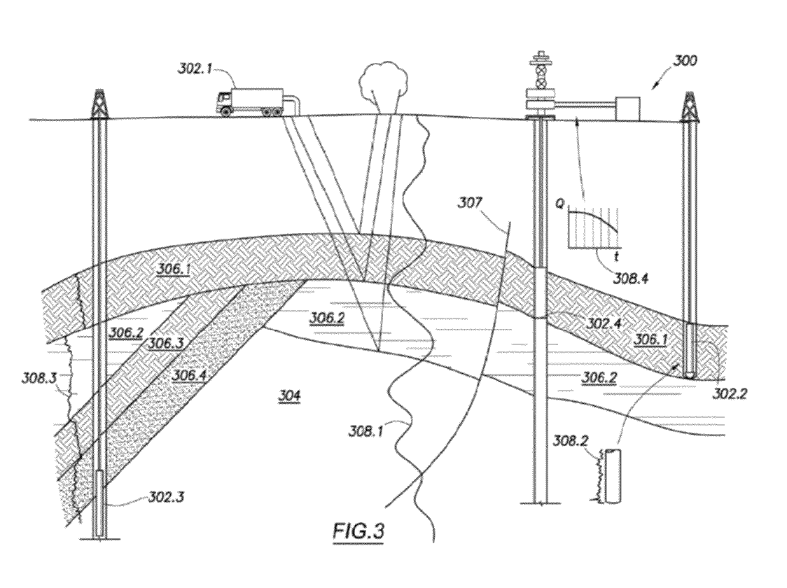

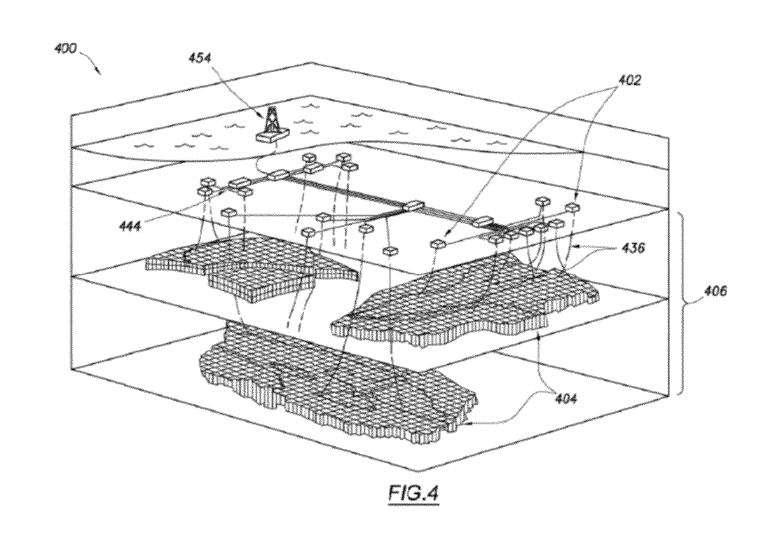

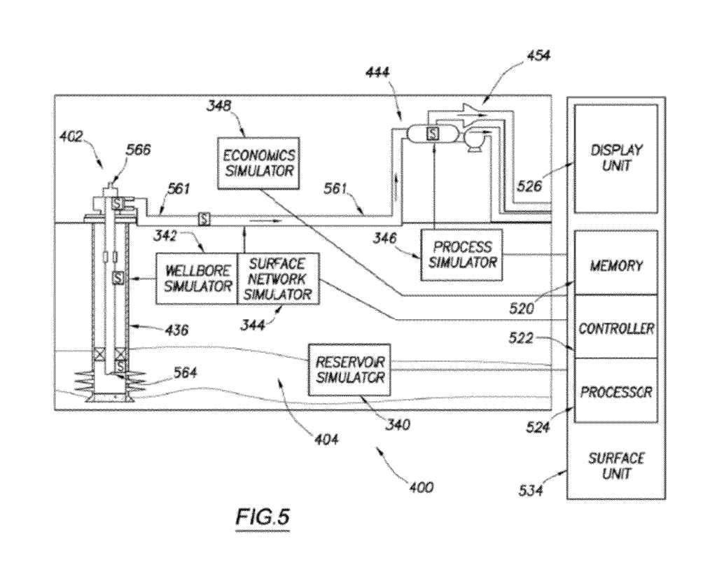

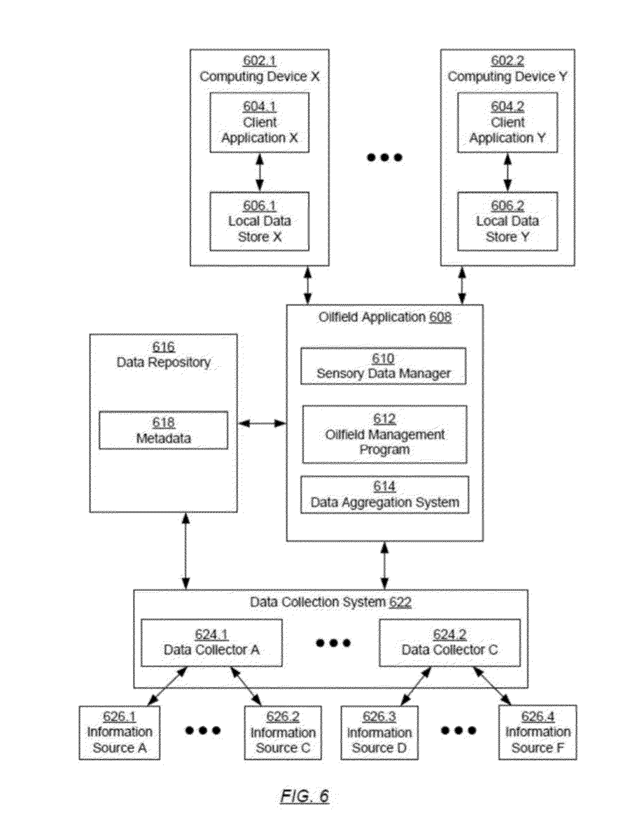

FIG. 3 is a schematic view, partially in cross section of a field (300) having data acquisition tools (302.1, 302.2, 302.3, and 302.4) positioned at various locations along the field for collecting data of a subterranean formation 304. The data acquisition tool (302.4) may be the same as data acquisition tool (106.4) of FIG. 1, respectively, or others not depicted. As shown, the data acquisition tools (302.1-302.4) generate data plots or measurements (308.1-308.4), respectively. These data plots are depicted along the field to demonstrate the data generated by various operations.

Data plots (308.1-308.3) are static data plots that may be generated by the data acquisition tools (302.1-302.4), respectively. Static data plot (308.1) is a seismic two-way response time. Static plot (308.2) is core sample data measured from a core sample of the formation (304). Static data plot (308.3) is a logging trace. Production decline curve or graph (308.4) is a dynamic data plot of the fluid flow rate over time, similar to the graph (206) of FIG. 2. Other data may also be collected, such as historical data, user inputs, economic information, and/or other measurement data and other parameters of interest.

The subterranean formation (304) has a plurality of geological formations (306.1-306.4). As shown, the structure has several formations or layers, including a shale layer (306.1), a carbonate layer (306.2), a shale layer (306.3) and a sand layer (306.4). A fault line (307) extends through the layers (306.1-306.2). The static data acquisition tools are adapted to take measurements and detect the characteristics of the formations.

While a specific subterranean formation (304) with specific geological structures is depicted, it will be appreciated that the field may contain a variety of geological structures and/or formations, sometimes having extreme complexity. In some locations, including below the water line, fluid may occupy pore spaces of the formations. Each of the measurement devices may be used to measure properties of the formations and/or its geological features. While each acquisition tool is shown as being in specific locations in the field, it will be appreciated that one or more types of measurement may be taken at one or more location across one or more fields or other locations for comparison and/or analysis.

The data collected from various sources, such as the data acquisition tools of FIG. 3, may then be processed and/or evaluated. Seismic data displayed in the static data plot (308.1) from the data acquisition tool (302.1) is used by a geophysicist to determine characteristics of the subterranean formations (304) and features. Core data shown in static plot (308.2) and/or log data from the well log (308.3) is used by a geologist to determine various characteristics of the subterranean formation (304). Production data from the graph (308.4) is used by the reservoir engineer to determine fluid flow reservoir characteristics. The data analyzed by the geologist, geophysicist and the reservoir engineer may be analyzed using modeling techniques.

Data may be collected by various sensors, for example, during drilling operations. Specifically, drilling tools suspended by a rig may advance into the subterranean formations to form a wellbore (i.e., a borehole). The borehole may have a trajectory in the subterranean formations that is vertical, horizontal, or a combination thereof. Specifically, the trajectory defines the path of the drilling tools in the subterranean formation. A mud pit (not shown) is used to draw drilling mud into the drilling tools via flow line for circulating drilling mud through the drilling tools, up the wellbore and back to the surface. The drilling mud is filtered and returned to the mud pit. Occasionally, such mud invades the formation surrounding the borehole resulting in an invasion. Continuing with the discussion of drilling operations, a circulating system may be used for storing, controlling, or filtering the flowing drilling mud. The drilling tools are advanced into the subterranean formations to reach reservoir. Each well may target one or more reservoirs.

The drilling tools are adapted for measuring downhole properties using logging while drilling tools. Specifically, the logging while drilling tools include sensors for gathering well logs while the borehole is being drilled. In one or more embodiments, during the drilling operations, the sensors may pass through the same depth multiple times. The data collected by the sensors may be similar or the same as the data collected by the sensors discussed below with reference to FIG. 5. During each pass of the drilling tools, the logging while drilling tools include functionality to gather oilfield data associated with a time of the pass and store such data into the well logs. In one or more embodiments, the logging while drilling tool may also be adapted for taking a core sample or removed so that a core sample may be taken using another tool.

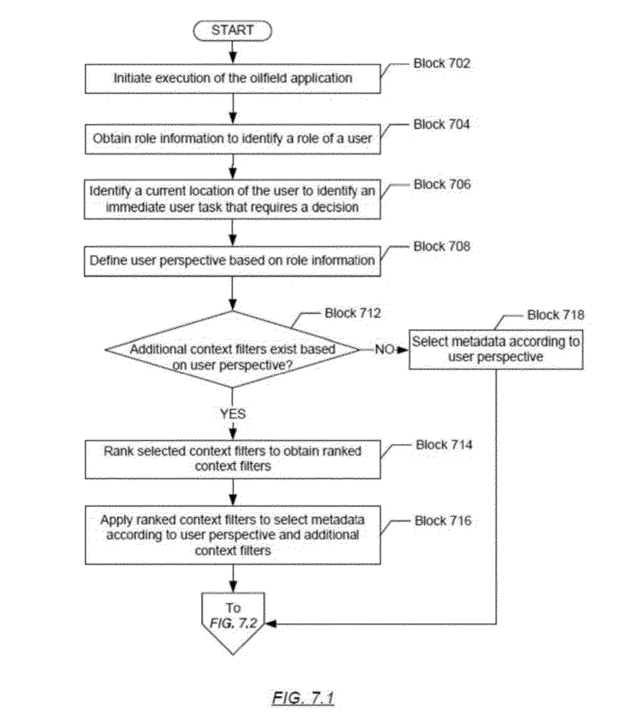

FIG. 4 shows a field (400) for performing production operations. As shown, the field has a plurality of wellsites (402) operatively connected to a central processing facility (454). The field configuration of FIG. 4 is not intended to limit improving production by actual loss allocation. The field or a portion of the field may be on land and/or sea. Also, while a single field with a single processing facility and a plurality of wellsites is depicted, any combination of one or more fields, one or more processing facilities and one or more wellsites may be present.

Each wellsite (402) has equipment that forms a wellbore (436) (i.e., borehole) into the earth. The wellbores extend through subterranean formations (406) including reservoirs (404). These reservoirs (404) contain fluids, such as hydrocarbons. The wellsites draw fluid from the reservoirs and pass them to the processing facilities via surface networks (444). The surface networks (444) have tubing and control mechanisms for controlling the flow of fluids from the wellsite to the processing facility (454).

FIG. 5 shows a schematic view of a portion (or region) of the field (400) of FIG. 4, depicting a producing wellsite (402) and surface network (444) in detail. The wellsite (402) of FIG. 5 has a wellbore (436) extending into the earth therebelow. As shown, the wellbore (436) has already been drilled, completed, and prepared for production from reservoir (404).

Wellbore production equipment (564) extends from a wellhead (566) of wellsite (402) and to the reservoir (404) to draw fluid to the surface. The wellsite (402) is operatively connected to the surface network (444) via a transport line (561). Fluid flows from the reservoir (404), through the wellbore (436), and onto the surface network (444). The fluid then flows from the surface network (444) to the process facilities (454).

As further shown in FIG. 5, sensors (S) are located about the field (400) to monitor various parameters during operations. The sensors (S) may measure, for instance, resistivity, pressure, temperature, flow rate, composition, and other parameters of the reservoir, wellbore, surface network, process facilities and/or other portions (or regions) of the operation. These sensors (S) are operatively connected to a surface unit (534) for collecting data therefrom. The surface unit may be, for instance, similar to the surface unit (134) of FIG. 1.

One or more surface units (534) may be located at the field 400, or linked remotely thereto. The surface unit (534) may be a single unit, or a complex network of units used to perform the data management functions throughout the field (400). The surface unit may be a manual or automatic system. The surface unit may be operated and/or adjusted by a user. The surface unit is adapted to receive and store data. The surface unit may also be equipped to communicate with various field equipment. The surface unit may then send command signals to the field in response to data received or modeling performed.

As shown in FIG. 5, the surface unit (534) has computer facilities, such as memory (520), controller (522), processor (524), and display unit (526), for managing the data. The surface unit (534) may be local or remote to the physical location of the wellsite. The data is collected in memory (520), and processed by the processor (524) for analysis. Data may be collected from the field sensors (S) and/or by other sources. For instance, production data may be supplemented by historical data collected from other operations, or user inputs.

The analyzed data (e.g., based on modeling performed) may then be used to make decisions. A transceiver (not shown) may be provided to allow communications between the surface unit (534) and the field (400). The controller (522) may be used to actuate mechanisms at the field (400) via the transceiver and based on these decisions. In this manner, the field (400) may be selectively adjusted based on the data collected. These adjustments may be made automatically based on computer protocol and/or manually by an operator. For example, based on revised log data, commands may be sent by the surface unit to the downhole tool to change the speed or trajectory of the borehole. In some cases, well plans are adjusted to select optimum operating conditions or to avoid problems.

To facilitate the processing and analysis of data, simulators may be used to process the data for modeling various aspects of the operation. Specific simulators are often used in connection with specific operations, such as reservoir or wellbore simulation. Data fed into the simulator(s) may be historical data, real time data or combinations thereof. Simulation through one or more of the simulators may be repeated or adjusted based on the data received.

As shown, the operation is provided with wellsite and non-wellsite simulators. The wellsite simulators may include a reservoir simulator (340), a wellbore simulator (342), and a surface network simulator (344). The reservoir simulator (340) solves for hydrocarbon flow through the reservoir rock and into the wellbores. The wellbore simulator (342) and surface network simulator (344) solves for hydrocarbon flow through the wellbore and the surface network (444) of pipelines. As shown, some of the simulators may be separate or combined, depending on the available systems.

The non-wellsite simulators may include process simulator (346) and economics (348) simulators. The processing unit has a process simulator (346). The process simulator (346) models the processing plant (e.g., the process facilities (454) where the hydrocarbon(s) is/are separated into its constituent components (e.g., methane, ethane, propane, etc.) and prepared for sales. The field (400) is provided with an economics simulator (348). The economics simulator (348) models the costs of part or the entire field (400) throughout a portion or the entire duration of the operation. Various combinations of these and other field simulators may be provided.

FIG. 6 shows a schematic diagram of a system in one or more embodiments. As shown in FIG. 6, the system includes one or more computing devices (e.g., computing device X (602.1) and computing device Y (602.2)), an oilfield application (608), a data repository (616), a data collection system (622), and one or more information sources (e.g., information source A (626.1), information source C (626.2), information source D (626.3), and information source F (626.4)). Each of these components is described below.

In one or more embodiments, a data repository (616) is any type of storage unit and/or device (e.g., a file system, database, collection of tables, or any other storage mechanism) for storing data. Further, the data repository (616) may include multiple different storage units and/or devices. The multiple different storage units and/or devices may or may not be of the same type or located at the same physical site.

In one or more embodiments, the data in the data repository (616) includes metadata (618). In one or more embodiments, metadata (618) is any data that describes the field, including the subsurface of the earth, wellsites, wellbores, pump stations, personnel located at the field or any other portion of the field. The metadata (618) is additional information to aid a user that is performing an oilfield task.

In one or more embodiments, metadata (618) includes historical data, alerts, measurements from sensors (e.g., FIG. 1 (S)), processed data from measurements, analyzed data (described above), personnel data, and supply chain data or any real-time data. In one or more embodiments, historical data is data that describes an event over time. For example, production success (e.g., how much fluid is extracted from a reservoir) at a wellsite may be stored each month.

In one or more embodiments, an alert is a notice of an irregular event or dangerous event to a user. For example, a driller may receive an alert. The alert may notify the driller that the subsurface is unstable at the driller's current location.

In one or more embodiments, a measurement from a sensor is real-time data that is collected by the sensor positioned about the field. In one or more embodiments, real-time data is data that is accessible during an oilfield task in the field. For example, the temperature, pressure, and flow rates within a wellbore may be determined by the sensor in the wellbore. Processed data from a measurement may correspond to data interpolated or derived from a measurement from a sensor. For example, the pressure and temperature may be determined by the sensor in the well. The density of the fluid may then be derived from the temperature and pressure.

In one or more embodiments, personnel data is any data about a user in the field. Personnel data may include hours of a user expended on an immediate task, a role of the user, an immediate task of the user. For example, a production manager may arrive at a rig site on the field. The production manager may be interested in the time spent by the drillers on fixing the pump at the rig site. The metadata of interest to the production manager is the hours spent fixing the pump and which of the personnel at the rig site have the role of driller.

Supply chain data is any data describing equipment or resources used in an oilfield task or equipment or resources that are out of service. For example, supply chain data may be a drilling tool that is out of service, a field tool that is not available as the field tool is in use, a driller required for an oilfield task, and a rig that is out of service. For example, a driller may decide the next wellsite to drill at based on which rigs are available.

In one or more embodiments, metadata (618) includes predictive data and current data. Predictive data is data that is expected based on extrapolating current data. In other words, predictive data is a possible future result if the trends in historical and current data remain the same. Predictive data may be data calculated based on a scenario. For example, historical data shows that the flow of drawing fluid from a wellsite has decreased each year. A production engineer may then obtain predictive data describing an expected amount of fluid in the next month from the wellsite. The production engineer may then choose to decrease the manpower at the wellsite. Current data is any data that is collected at the time during which an oilfield task is performed. For example, if the oilfield task is drilling a borehole using a logging while drilling tool, current data may be logs recorded by a sensor on the logging while drilling tool.

In one or more embodiments, metadata (618) augments an oilfield task by adding content to an oilfield output. In one or more embodiments, the oilfield output is any data a user in the field may visualize in a field of view of a computing device (e.g., computing device X (602.1) and computing device Y (602.2)) discussed below. A field of view is the extent of the real world a computing device can capture. Said another way, the field of view is the area of the real world visible using a computing device. For example, a camera on a computing device is limited to a field of view of 50 cm by 40 cm.

A user is any person working in the field. For example, the user may be a driller, a drilling engineer, a production engineer, a geologist, a field engineer, and a geophysicist.

An oilfield task is any task a user performs during an oilfield operation (e.g., exploration, drilling, production). An oilfield task includes performing Blocks in a workflow, reading measurements from wellsites, drilling, troubleshooting at a pump station, and determining fluid flow reservoir characteristics, characteristics of subterranean formations, and locations of wellsites.

The data repository (616) is operatively connected to a data collection system (622) and an oilfield application (608) in accordance with one or more embodiments.

In one or more embodiments, a data collection system (622) may be software, hardware, or a combination thereof. For example, Avocet is software that collects any production related information (Avocet is a mark of Schlumberger, Inc. located in Houston, Tex., USA). The data collection system (622) includes one or more data collectors (e.g., data collector A (624.1), data collector B (624.2), and data collector C (624.3)). The data collection system (622) includes functionality to receive metadata (618) from one or more data collectors and store the metadata in the data repository (616).

In one or more embodiments, a data collector (e.g., data collector A (624.1), data collector B (624.2), and data collector C (624.3)) is operatively connected to one or more information sources (e.g., information source A (626.1), information source C (626.2), information source D (626.3), and information source F (626.4)) in accordance with one or more embodiments. A data collector may be software, hardware, or a combination thereof. A data collector includes functionality to receive metadata (618) from one or more information sources. A data collector may be located at the field or linked remotely thereto. A data collector includes a user manually inputting data from an information source, a surface unit (e.g., FIG. 1 (134)), or any hardware and/or software that may collect data from the field.

In one or more embodiments, an information source (e.g., information source A (626.1), information source C (626.2), information source D (626.3), and information source F (626.4)) is a source of metadata (618). An information source includes a sensor positioned about the field (e.g., FIG. 1 (S)), a data acquisition tool (e.g., FIG. 3 (302.1, 302.2, 302.3, and 302.4), and a user. For example, during a task at a site, a drilling engineer discovers that a zone is dangerous. The drilling engineer acts as an information source by identifying the zone as a dangerous zone requiring a heightened state of alert.

In one or more embodiments, an oilfield application (608) may be software, hardware, or a combination thereof. The oilfield application (608) includes a data aggregation system (614), an oilfield management program (612), and a sensory data manager (610). Each of these components is described below.

In one or more embodiments, the data aggregation system (614) includes functionality to aggregate information obtained from the data collection system (622). The data aggregation system includes further functionality to store the aggregated information in the data repository (616). For example, Studio is software that aggregates and manages information (Studio is a mark of Schlumberger, Inc. located in Houston, Tex., USA). For example, any data collected from a sensor that affects production may be aggregated into a production set of data. Any data collected from a sensor that affects drilling may be aggregated into a drilling set of data.

In one or more embodiments, the oilfield management program (612) includes functionality to perform an immediate user task with a user. In one or more embodiments, an immediate user task of the user is a real-time oilfield task of the user, including troubleshooting at a pump station, verifying measurements at a wellsite, and drilling.

In one or more embodiments, the sensory data manager (610) includes functionality to obtain role information of the user to identify a role of the user, and select metadata (618) accordingly. The sensory data manager (610) includes further functionality to encode oilfield output with selected metadata. The selected metadata is based on the user perspective of the user on an immediate user task the user is performing in the field.

The oilfield application (608) is operatively connected to the data repository (616) and one or more computing devices (e.g., computing device X (602.1) and computing device Y (602.2)) in accordance with one or more embodiments.

In one or more embodiments, a computing device (e.g., computing device X (602.1) and computing device Y (602.2)) is a hardware device that includes at least a microprocessor. A microprocessor may be an integrated circuit for processing instructions. The computing device may include a tablet, smart safety glasses, headphones, a wearable tactile device (e.g., gloves that heat up and/or cool down based on input) with at least a microprocessor, change color based on input), clothing and other accessories with at least a microprocessor, a laptop computer, a smartphone or any other computing device that may operate in the field. In one or more embodiments, computing devices are located on the field. However, the computing devices may be remote from each other, the data repository (616), the data collection system (622), and the information sources (e.g., information source A (626.1), information source C (626.2), information source D (626.3), and information source F (626.4)).

In one or more embodiments, the computing device includes a client application (e.g., client application X (604.1) and client application Y (604.2) and a local data store (e.g., local data store X (606.1) and local data store Y (606.2)). The client application is an instance of the oilfield application (608). An instance of the oilfield application is an executable copy of the oilfield application (608). The client application includes functionality to query a user of the client application on role information. Role information is data about the user that may identify the role of the user. For example, the role of the user may be determined from the name of the user. In one or more embodiments, the role of a user is the job title of a user in an immediate user task in the field. The role may include driller, field engineer, production engineer, geologist, drilling engineer, field engineer, and geophysicist, or any other profession or job title of the user. The client application includes further functionality to present any metadata (618) from the oilfield application to a user of the client application.

In one or more embodiments, each client application may not present, encode the same metadata or have access to the same features from the oilfield application. A feature of the oilfield application is a functionality in the oilfield application. A feature may include a tool, a workflow, and access, display, and analysis of metadata. For example, a driller using client application X (604.1) may be performing a drilling task. The production features of the oilfield application may be disabled on the client application X (604.1). When the driller faces a tablet towards a wellsite, the metadata visible to the driller in the client application X (604.1) describes the location of the drilling tools. Facing a computing device, such as a smartphone or tablet, towards a wellsite is to position the camera of the computing device in the direction of the wellsite, such that an image of the wellsite as currently viewable is shown in the display of the computing device. Similarly, a production engineer using client application Y (604.2) may be performing a production task. The drilling features of the oilfield application may be disabled on the client application Y (604.2). When the production engineer faces a smartphone towards a wellsite, the metadata visible to the production engineer in the client application Y (604.2) describes the predicted production from the wellsite.

In one or more embodiments, local data store (e.g., local data store X (606.1) and local data store Y (606.2)) is in the computing device. The local data store is any type of storage unit (e.g., database, collection of tables, or any other storage mechanism) for storing data. The local data store stores metadata and the role information for a user of the computing device.

While FIGS. 1-6 show various configurations of components, other configurations may be used without departing from the scope. For example, various components may be combined to create a single component. As another example, the functionality performed by a single component may be performed by two or more components.

Further, an alternate configuration may not include a component. For example, a computing device may directly access the oilfield application or data repository rather than executing a client application or having local data store.

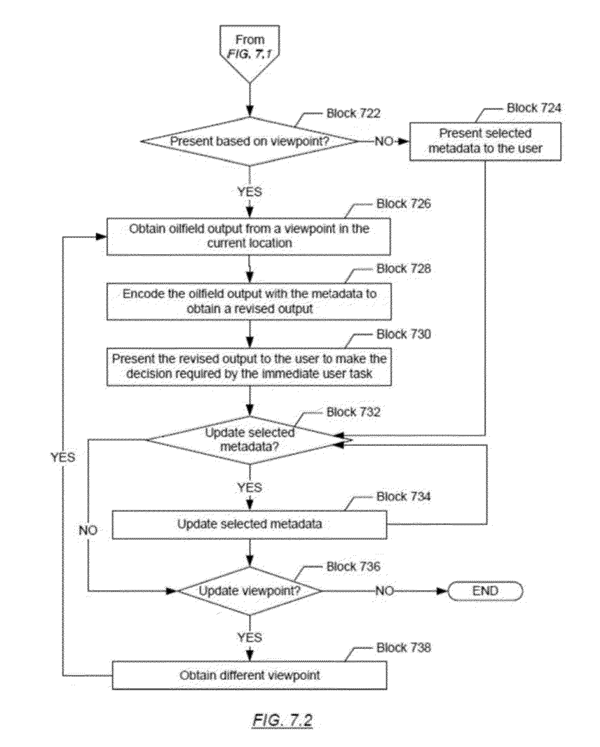

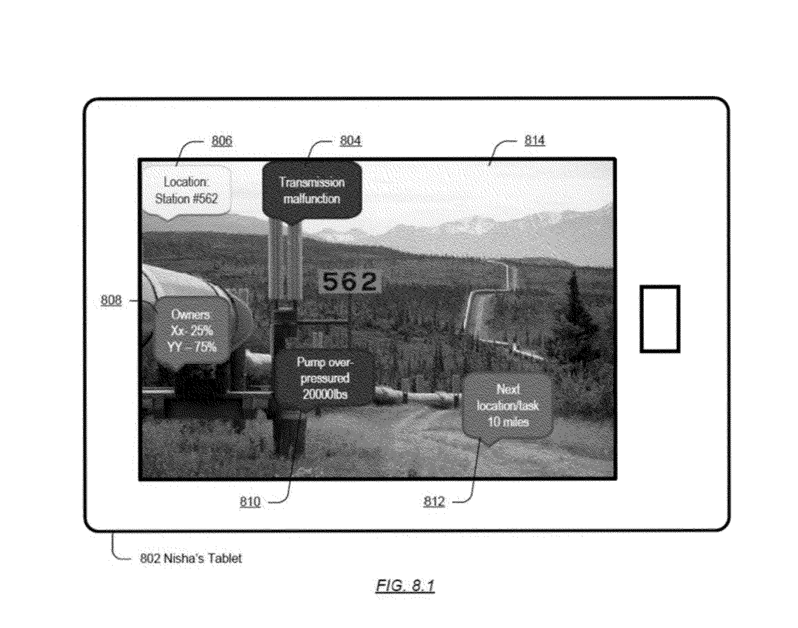

FIGS. 7.1, 7.2 show a flowchart in one or more embodiments. While the various Blocks in this flowchart are presented and described sequentially, one of ordinary skill will appreciate that the Blocks or some of the Blocks may be executed in different orders, may be combined or omitted, and the Blocks or some of the Blocks may be executed in parallel. Furthermore, the Blocks may be performed actively or passively. For example, some Blocks may be performed using polling or be interrupt driven in accordance with one or more embodiments. By way of an example, determination Blocks may not require a processor to process an instruction unless an interrupt is received to signify that condition exists in accordance with one or more embodiments. As another example, determination Blocks may be performed by performing a test, such as checking a data value to test whether the value is consistent with the tested condition in accordance with one or more embodiments.

FIGS. 7.1 and 7.2 show a flowchart for presenting an oilfield output encoded with selected metadata to a user in one or more embodiments.

In Block 702, the execution of the oilfield application is initiated. In one or more embodiments, the execution of the oilfield application is initiated by a user on a computing device, such as a tablet, smartphone, and laptop. In one or more embodiments, the execution of the oilfield application is automatically initiated at the boot-up of a computing device. In one or more embodiments, the oilfield application is a background process on a computing device. The oilfield application may execute while a user is located on the field and/or travelling to the field in one or more embodiments.

In Block 704, role information is obtained to identify a role of a user. In one or more embodiments, role information may be obtained by a user manually entering the name of the user or the role of the user on a computing device. The role may also be derived based on information a user manually enters on a computing device, including an oilfield task and project location.

In one or more embodiments, the role information may be automatically obtained from a human resources system. For example, the username of a user on a computing device may be mapped to a record in a human resources system. The mapping may then be used to identify a role of the user. In one or more embodiments, the human resources system stores data about each user that has a role at an oilfield company, including role information. An oilfield company is a company that drills and produces hydrocarbons.

In Block 706, a current location of the user is identified to identify an immediate user task of the user that includes a decision. In one or more embodiments, the immediate user task is identified by the current location of the user and the role of the user obtained in Block 704. In one or more embodiments, the current location of the user is the real-time location of the user in the field. As described above, in one or more embodiments, real-time corresponds to the present time in the field.

Continuing with Block 706, in one or more embodiments, the current location of the user may be identified automatically using a global positioning system (GPS) or a GPS embedded in a computing device. In one or more embodiments, the user may manually enter the current location of the user in the oilfield application. In one or more embodiments, the oilfield application may automatically identify the current location of the user using assigned immediate user tasks from the human resources system described above.

Continuing with Block 706, the current location of the user identifies an immediate user task of the user by locating the objects in the field that are within a radius to the current location in one or more embodiments. Objects are any component of the field, such as geological structures, personnel, and oilfield equipment. Objects include a well, a wellsite, a pump, a rig, a pipe, or any component of the field. The object and the role identified in Block 704 may identify an immediate user task of the user. The supply chain data described above may also be used to describe the real-time equipment of the user. In one or more embodiments, the real-time equipment of the user and the current location of the user may identify an immediate user task of the user.

For example, a driller's current location is at a rig site. The driller's equipment is a transmission pump. From the driller's current location and the driller's equipment, an immediate user task of replacing the transmission of the pump at the rig site is identified.

In Block 708, a user perspective based on the role information obtained in Block 704 is defined. In one or more embodiments, a user perspective is a point of view of the user on the immediate user task identified in Block 706. The point of view of the user defines what is interesting to the user based on the skills required by a role of the user. For example, a faulty field tool is of no interest to a driller. The drilling tools are of interest to the driller as the driller is trained to use the drilling tools. As an example, a user perspective of a driller at a wellsite may correspond to ensuring the drilling is safe. In contrast, a user perspective of a production engineer at a wellsite may correspond to ensuring that a rate of flow of a wellbore meets the required rate of flow determined by a production manager.

Continuing with Block 708, the user perspective is defined by limiting the point of view of the user to an oilfield area of interest determined by the role information in one or more embodiments. An oilfield area of interest is portion of the operations in the field that are interesting to the user. For example, a production engineer may be limited to the operational phase of production. In one or more embodiments, the user perspective of a user based on role information is not the same as the user perspective of another user that has different role information.

For example, a user perspective of a structural geologist looking at a portion of the surface of the earth is the characteristics of subterranean formation. However, a user perspective of a driller looking at the same portion of the surface of the earth as the structural geologist differs. The user perspective of the driller is the danger of drilling at that portion of the surface of the earth. Although both the structural geologist and the driller are looking at the same portion of the earth, the user perspective differs.

In Block 712, a determination is made whether additional context filters exist based on the user perspective. In one or more embodiments, an additional context filter is a filter that further limits the area of interest of the user. For example, a user perspective of a production engineer may be the production phase in the field. However, the user perspective may be further limited by an urgent matters context filter. Using the urgent matters context filter, the production engineer is limited to urgencies that affect productivity of the immediate task, such as a blocked pipe.

Additional context filters may include the current location of the user, schedule of the user, historical trends of the immediate user task, equipment of the immediate user task, team information of the user, and goals of the immediate user task. The current location of the user is described above. In one or more embodiments, a schedule of the user is a list of the oilfield tasks for the user, including the immediate task of the user. In one or more embodiments, historical trends of the immediate user task are historical data that may predict a trend for the immediate user task. In one or more embodiments, equipment of the immediate user task is any tools or mechanical devices that a user uses to complete the immediate user task. In one or more embodiments, team information of the user is the personnel working alongside the user on an immediate user task. Goals of the immediate user task are any requirements to complete the immediate user task in one or more embodiments.

In one or more embodiments, determining whether additional context filters exist based on the user perspective may correspond to a search of a set of additional context filters. In one or more embodiments, the set of additional context filters includes additional context filters regardless of the user perspective. A search of the set of additional context filters may be based on keywords from the user perspective defined in Block 708. As an example, a user perspective of a driller may correspond to drilling. Additional context filters may be searched based on the keyword “drilling” and any variation of the keyword, such as “driller” and “drill”. Additional context filters are found and may include available drilling tools at the present time, drillers at the driller's current location, and drilling safety at the driller's current location. If the determination is made that additional context filters exist based on the user perspective, the method may proceed to Block 714.

In Block 714, the selected context filters are ranked to obtain ranked context filters. In one or more embodiments, the selected context filters are ranked by the context filter's relevance with respect to the immediate user task and/or current location of the user. For example, a driller that has an immediate user task of drilling. The current location of the driller is dangerous. Based on the current location and the immediate user task, a drilling safety at the driller's current location context filter is more relevant to the driller than a drilling tools at the present time context filter.

In Block 716, the ranked context filters are applied to select metadata according to the user perspective and additional context filters. In one or more embodiments, selecting metadata is first selected according to the user perspective and then further limited by applying the ranked context filters. In one or more embodiments, applying the ranked context filters may correspond to first applying the top ranked context filter, then applying the next ranked context filter and so on.

If the determination is made that additional context filters do not exist based on the user perspective, the method may proceed to Block 718. In Block 718, metadata is selected according to the user perspective. In one or more embodiments, the selected metadata in Block 716 is more limited than the selected metadata from Block 718. As an example, selecting metadata according to the user perspective of a production engineer may be color coding of each pipe at a production engineer's current location to show the rate of flow in each pipe. In contrast, selecting metadata according to the user perspective and the ranked context filters may further limit the selected metadata to color coding of each pipe that has a rate of flow that is less than half of the previous day.

In Block 722, a determination is made whether to present the selected metadata to the user based on a viewpoint. If a determination is made to present the selected metadata to the user based on a viewpoint, the method proceeds to Block 726. In Block 726, oilfield output is obtained from a viewpoint in the current location of the user. As described above, an oilfield output is any data a user in the field may visualize in a field of view of a computing device in one or more embodiments. In one or more embodiments, the viewpoint is the direction a computing device is facing. Said another way, the viewpoint is the point of view of a computing device. The field of view may be visible using a camera, or any device that provides vision to the user.

For example, a production engineer has a current location by a well in the field and faces the well. Without changing direction, the production engineer raises a tablet. The viewpoint of the production engineer is the direction the production engineer faces the tablet towards the well. The oilfield output is the image of the well displayed in the field of view of a camera in the tablet from the viewpoint of the production engineer.

In Block 728, the oilfield output obtained in Block 726 is encoded with the selected metadata to obtain a revised output. In one or more embodiments, a revised output is the oilfield output with additional information displayed in the form of the selected metadata.

In one or more embodiments, encoding the oilfield output may correspond to overlaying the selected metadata on the oilfield output. Overlaying metadata may include overlaying text or a graphic. A graphic may include an image, a video, or any visualization that may be overlaid on an oilfield output. For example, a user visualizing a well may have the recordings from a sensor in the well overlaid on the well as text. The selected metadata overlaid on the oilfield output is the revised output.

For example, a geologist facing a smartphone towards a portion of the surface of the earth may visualize an image of the portion of the surface. Percentages of the minerals and/or elements in the subsurface below the portion of the surface are overlaid on the image. As another example, a production engineer may visualize the flow of fluid in a pipe by facing a tablet towards the pipe. The pipe is visible in the field of view of a camera of the tablet from the viewpoint of the production engineer. While the tablet faces the pipe, no alerts are displayed signifying that the flow of the pipe is in the normal range. Although the previous example uses a camera on a tablet to visualize the pipe, one of ordinary skill in the art recognizes that any augmented reality device may be used to visualize a field of view of a person in the field.

In one or more embodiments, encoding the oilfield output with the selected metadata may correspond to altering the display of objects in the oilfield output. Altering the display may include color coding an object in the oilfield output based on the selected metadata in one or more embodiments. Color coding corresponds to assigning a color to an object to identify a property. A property is a characteristic, attribute or quality of an object. A property may include a temperature, a thickness, and a material of an object.

For example, a driller feels that a drilling tool is overheating and wants to verify the temperature. The driller may face a tablet towards the drilling tool, such that the drilling tool is in the field of view of a camera of the tablet. On the display of the tablet, the drilling tool is displayed in orange signifying that although the drilling tool is hot, the drilling tool is safe to use. As another example, a production engineer visualizes a pipe as the oilfield output from the production engineer's laptop. The fluid flow of the pipe may be color coded based on the rate of flow. The production engineer then gains an understanding of the real-time rate of flow through the color coding.

In Block 730, the revised output is presented to the user. In one or more embodiments, the user is presented with the revised output in a computing device. In one or more embodiments, the user is presented with the revised output during an immediate user task and in a current location of the user in the field. The revised output is presented to the user by showing a visual of the revised output in one or more embodiments. Since the revised output is presented to the user during the immediate user task, the user may base a decision of the immediate user task on the revised output that is presented.

For example, a drilling engineer assesses the current state of a well by facing a tablet towards the well. The decision of a drilling engineer to continue the drilling operation at the well is based on the revised output on the tablet. The revised output shows the pressure and temperature of the well overlaid on the image of the well.

In Block 732, a determination is made whether the selected metadata has updated. In one or more embodiments, the determination whether the selected metadata has updates occurs if any of the selected metadata is different compared to the selected metadata initially selected in Block 716 or Block 718. In one or more embodiments, the determination whether the selected metadata has updated occurs while the oilfield output remains the same. The oilfield output remains the same when the objects in the oilfield output are the same. In one or more embodiments, an object recognition algorithm, such as background subtraction, may be used to verify that the oilfield output remains the same. Background subtraction removes the background from an image and emphasizes the foreground objects of the image. The oilfield output may remain the same when the foreground objects of the image may have moved, but remain in the field of view. For example, a tablet held by a drilling engineer to visualize a well may not remain perfectly still; however, the movements of the tablet do not remove the well from the field of view of a camera in the tablet.

If a determination is made that an update to the selected metadata exists, the method may proceed to Block 734. In Block 734, the selected metadata is updated. In one or more embodiments, the update is a real-time change to the selected metadata. Since an oilfield output exists, Block 728 is then executed to encode the update to the selected metadata that is overlaid on the oilfield output. For example, a sensor (e.g., FIG. 1 (S)) in a well in the field collects real-time measurements. As a driller is looking at an image of a well as an oilfield output, the temperature measurement from the sensor is overlaid on the image of the well. Any change in the temperature updates the temperature overlaid on the image of the well.

If a determination is made that an update to the metadata does not exist, the method may proceed to Block 736. In Block 736, a determination is made whether to update the viewpoint. In one or more embodiments, a user may visualize more than one oilfield output captured from a different viewpoint to complete an immediate user task. For example, a production engineer may need verify the rate of flow of fluid in pipes in two locations to determine the location to add more drillers.

If a determination is made to update the viewpoint, the method proceeds to Block 736. In one or more embodiments, the determination to update the viewpoint is based on whether different objects are displayed in the field of view of a camera in a computing device. In one or more embodiments, the determination to update the viewpoint may use an object recognition computer algorithm to automatically identify objects. In one or more embodiments, the identification of objects may correspond to matching a computer-aided design (CAD) model of a tool to a tool in the image. A CAD model is a mechanical drawing of a tool produced on a computing device. In one or more embodiments, the identification of objects may also correspond to matching features to objects in the image. A feature is a visual property of an object. For example, the size and shape of a well are features that distinguish the well from other objects in the field.

In Block 736, a different viewpoint is obtained. In one or more embodiments, the different viewpoint is obtained by changing the direction of a computing device to capture another field of view. The method then returns to Block 726 to obtain the oilfield output from the different viewpoint obtained.

Returning to Block 722, if a determination is made not to present the selected metadata to the user based on a viewpoint, the method proceeds to Block 724. In one or more embodiments, the determination not to present the selected metadata to the user is based on a delivery method of the selected metadata. In one or more embodiments, the delivery method is the method the selected data is presented to the user. Delivery methods include, visual, auditory, and vibratory. In one or more embodiments, the determination not to present the selected metadata occurs for an auditory and/or a vibratory delivery method of the selected metadata. The method then proceeds to Block 734 to determine if any updates to the selected metadata exist.

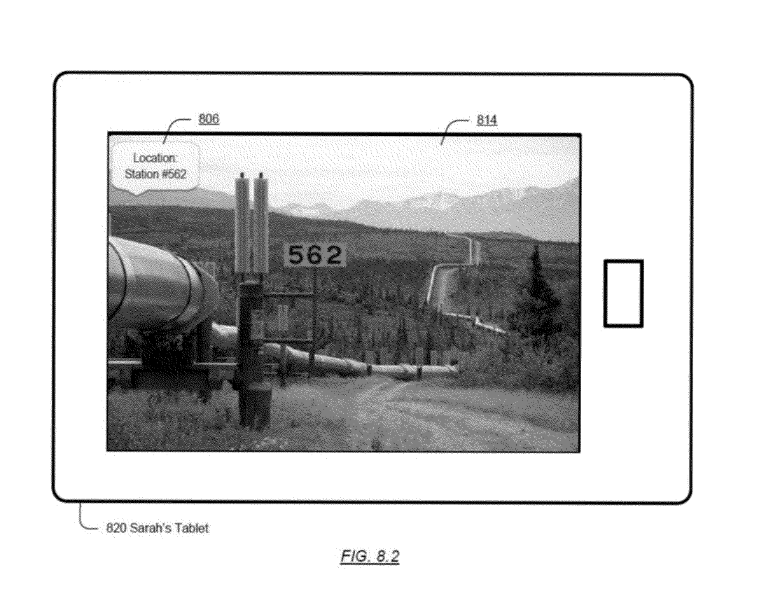

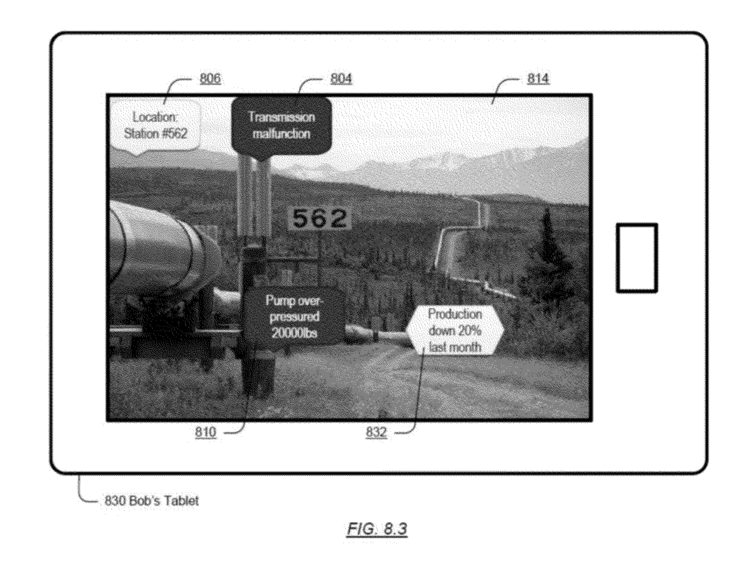

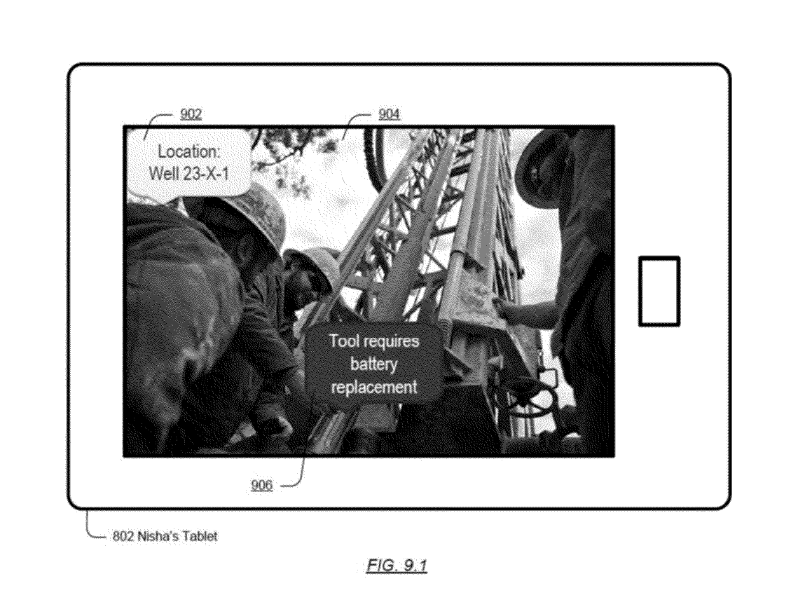

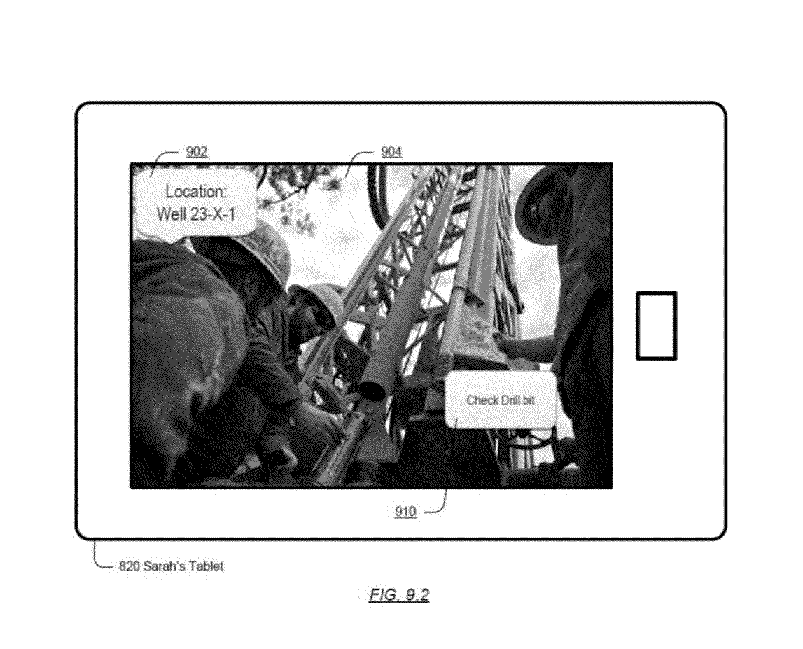

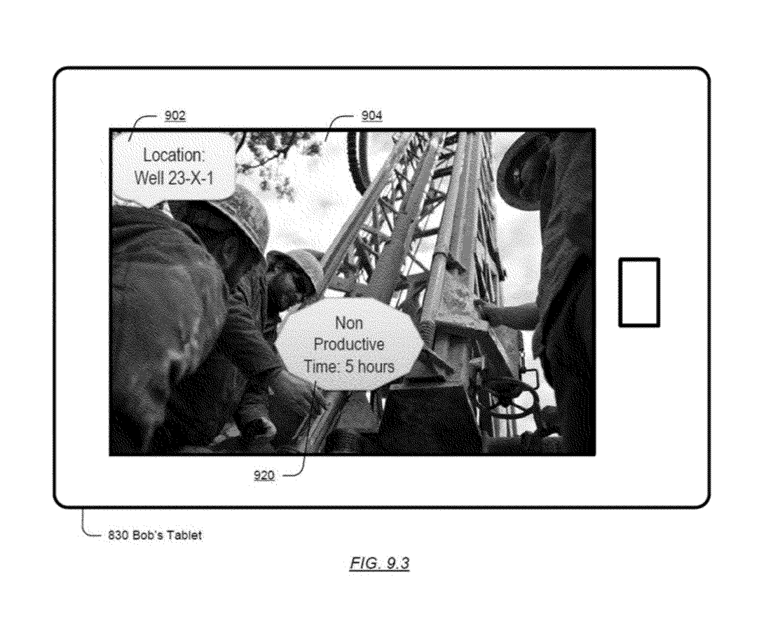

For example, a drilling engineer has a smartphone in the drilling engineer's tool belt and travels to a wellbore. The drilling engineer's smartphone vibrates to send an alert to the drilling engineer that an immediate user task of creating fractures in the wellbore is delayed. The alert may also suggest an alternate immediate user task the drilling engineer may complete during the delay. As another example, background music on a production engineer's tablet increases in volume while the production engineer is walking on the surface of the earth in areas where the subterranean formations are predicted to produce oil. FIGS. 8.1, 8.2, and 8.3 show an example oilfield output with selected metadata based on a user perspective in one or more embodiments. Consider the scenario in which three different users Nisha, Sarah, and Bob visualize the same oilfield output at a pump site. However, the selected metadata overlaid on the oilfield output differs for each user.

Turning to FIG. 8.1, Nisha reaches a pump site. Nisha then logs into Nisha's tablet (802) using a username. The client application is running in the background of Nisha's tablet. Nisha is recognized as a field engineer by mapping the username entered by Nisha to Nisha's human resources record. Nisha's current location is identified as the pump site by accessing the GPS of Nisha's tablet. The immediate user task is identified as checking the pump function from Nisha's current location and Nisha's role as a field engineer. Nisha's user perspective is then defined as level 1 field engineer based on role information in Nisha's human resources record.

Additional context filters exist based on Nisha's user perspective of level 1 field engineer. The additional context filters include Nisha's current field location and field schedule context filter (hereinafter, “schedule filter”) and pump functionality context filter (hereinafter, “functionality filter”). The schedule filter is ranked as more relevant than the functionality filter based on the requirements of a level 1 field engineer. The level 1 field engineer is required to visit each pump site on the schedule of the level 1 engineer. However, it is recommended to a field engineer to submit a report on the functionality of pumps visited each day. The metadata is then selected first according to the level 1 field engineer perspective, then the schedule filter is applied followed by the functionality filter.

Continuing with FIG. 8.1, the selected metadata (e.g., 804, 806, 808, 810, 812) has a visual delivery method. Therefore, Nisha is prompted by an auditory alert to visualize the pump site in the field of view of a camera on Nisha's tablet (802). The image of the pump site is the oilfield output (814). Nisha then views the selected metadata overlaid on the oilfield output (814). Nisha visualizes a location callout (806) as a selected metadata displaying location station #562. Based on the location callout (806), Nisha adds to the report that Nisha is at location station #562. A transmission callout (804) displayed on the oilfield output (814) indicates that there is a transmission malfunction. A pump callout (810) overlaid on the oilfield output (814) shows that the pump is over pressured by 20000 lbs. Nisha then deduces that the transmission malfunction is due to a pump over pressured by 20000 pounds. From the owners callout (808) overlaid on the oilfield output (814), Nisha visualizes the owners by percentage. Nisha then determines the recipients of the report by the owner's callout (808). Based on the selected metadata overlaid on the pump site, Nisha makes the decision to alert Bob, a lead production engineer. Nisha then moves on to the next pump site located 10 miles away from Nisha's current location to ensure visiting each pump on Nisha's schedule.

Turning to FIG. 8B, Sarah reaches a pump site to deliver a field tool to Nisha. While waiting for Nisha to return the field tool, Sarah decides to pull out Sarah's tablet (820) to see how what she visualizes differs from Nisha. Sarah opens the client application and manually enters Sarah as the name of the user and Sarah's current location coordinates for the current location. Sarah is recognized as a diagnostic drilling engineer by mapping the name entered by Sarah to Sarah's human resources record. No immediate task is found based on Sarah's current location and Sarah's role as a diagnostic drilling engineer. Sarah visualizes from the same viewpoint as Nisha to obtain the image of the pump site as the oilfield output (814). The location callout (806) indicating that the location is station #562 is overlaid on the oilfield output (814).

Turning to FIG. 8C, Nisha sends an alert to Bob's tablet (830) to notify Bob that the pump site has functionality issues. Bob receives the alert and travels to the pump site. When Bob reaches the pump site, Bob uses Bob's tablet (830) to visualize the pump. Bob has the client application and production engineering software running in the background of Bob's tablet (830). The production engineering software is limited to production engineers that have a license to use the production engineering software. From the production engineering software, the client application identifies Bob's role as a lead production engineer. The Bob's current location is identified by the GPS of Bob's tablet (830). Bob's user perspective is then defined as lead production engineer.

Continuing with FIG. 8C, additional context filters do not exist based on the user perspective as lead production engineer. The metadata is then selected based on the user perspective as a lead production engineer. The selected metadata (e.g., 804, 806, 810, and 832) is overlaid on the oilfield output (814). The oilfield output (814) is the same image of the pump site that both Nisha and Sarah visualized. From the location callout (806) displaying location station #562, Bob notes that Bob is at the same location as Nisha. Bob also notes from viewing the transmission callout (804) that there is a transmission malfunction. The pump callout overlaid on the oilfield output (814) shows the same over pressured value of 20000 lbs for the pump that Nisha discussed in the alert. Bob is alarmed by the production callout (832) that displays that the production was down 20% last month. Based on the selected metadata overlaid on the pump site visualization, Bob decides to fix the transmission malfunction.

FIGS. 9.1, 9.2, 9.3 show an example of another oilfield output with selected metadata based on a user perspective in one or more embodiments. Consider the scenario in which three different users Nisha, Sarah, and Bob visualize the same oilfield output at a rig site. However, the metadata overlaid on the oilfield output differs for each user.

Turning to FIG. 9.1, Nisha remains logged into Nisha's tablet (802). The client application session from FIG. 8.1 continues to run in the background. Nisha's user perspective as a level 1 field engineer is known from the client application session from FIG. 8.1. However, the GPS in Nisha's tablet (802) identifies a different current location. The current location is identified as a rig site at well 23-X-1. The immediate user task is identified as checking the function of well 23-X-1.

The additional context filters include a field engineering tools context filter, field engineering functionality context filter, and field engineering location context filter. The metadata is first selected based on Nisha's user perspective. The metadata is then limited by the field engineering location context filter, followed by the field engineering tools context filter, and finally the field engineering functionality context filter.

Continuing with FIG. 9.1, Nisha visualizes the rig site as the oilfield output (904). The selected metadata (e.g., 902 and 906) is overlaid on the oilfield output (904). Nisha first visualizes a location callout (902). The location callout (902) depicts that the location is well 23-X-1. A battery callout (906) displays that a tool requires a battery replacement. After visualizing the battery callout (906), Nisha then proceeds to change the battery on the tool.

Turning to FIG. 9.2, Sarah is also at the rig site at well 23-X-1. Now that Nisha replaced the battery, Sarah attempts to resume drilling. However, another problem exists. Sarah cannot identify the problem and decides to visualize the rig site with Sarah's tablet. Sarah's tablet (820) is running the client application session from FIG. 8.2. Similarly to Nisha, Sarah's current location is updated on Sarah's tablet (820). The immediate user task of diagnosing drilling at well 23-X-1 is identified by Sarah's role as a diagnostic drilling engineer and Sarah's current location at the rig site of well 23-X-1. Sarah's user perspective is defined as diagnostic drilling engineer based on Sarah's role information. Sarah visualizes the rig site as the oilfield output (904) from Sarah's tablet (820).

No additional context filters exist. The selection of metadata is based on Sarah's user perspective as a diagnostic drilling engineer. The selected metadata (e.g., 902 and 910) is overlaid on the oilfield output (904). The location callout (902) displays Sarah's current location as location well 23-X-1. The drill callout (910) is a visual reminder to check the drill bit. Sarah then recognizes that the drill bit is faulty.

Turning to FIG. 9.3, Bob arrives at the rig site at well 23-X-1 to survey the production loss at well 23-X-1. Bob's tablet (830) is running the client application session from FIG. 8.3. Similarly to Nisha and Sarah, Bob's current location is updated on Bob's tablet (830). Bob visualizes the oilfield output (904) of the rig site both Nisha and Sarah visualized on Bob's tablet (830).

No additional context filters exist. The selection of metadata is based on Bob's user perspective as a lead production engineer from FIG. 8.3. The selected metadata (e.g., 902 and 920) is overlaid on the oilfield output (904). The location callout (902) overlays that the location is well 23-X-1. The production callout (904) indicates visually on the oilfield output (904) that the non productive time is 5 hours. From the production callout (904), Bob discovers that the production time lost of the well 23-X-1 is 5 hours.

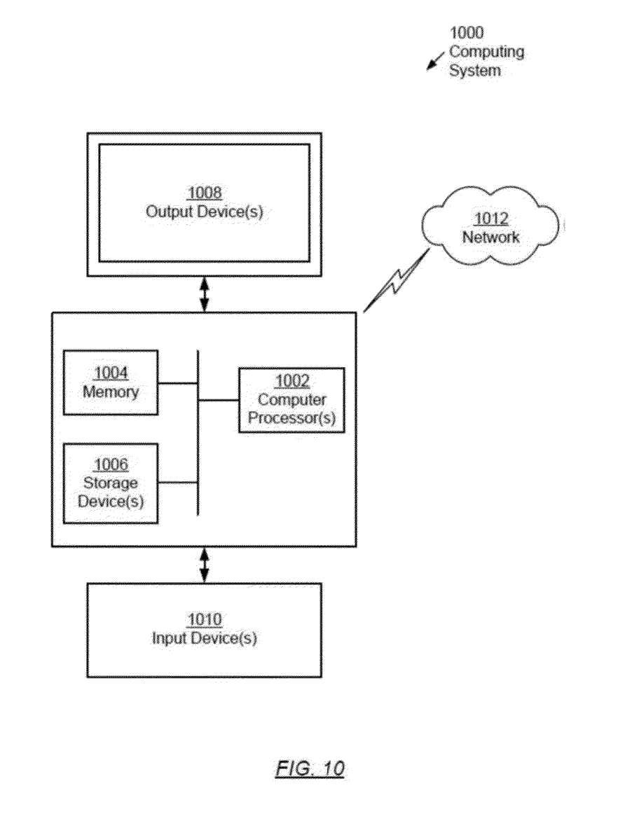

Embodiments may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments. For example, as shown in FIG. 10, the computing system (1000) may include one or more computer processor(s) (1002), associated memory (1004) (e.g., random access memory (RAM), cache memory, flash memory, etc.), one or more storage device(s) (1006) (e.g., a hard disk, an optical drive such as a compact disk (CD) drive or digital versatile disk (DVD) drive, a flash memory stick, etc.), and numerous other elements and functionalities. The computer processor(s) (1002) may be an integrated circuit for processing instructions. For example, the computer processor(s) may be one or more cores, or micro-cores of a processor. The computing system (1000) may also include one or more input device(s) (1010), such as a touchscreen, keyboard, mouse, microphone, touchpad, electronic pen, or any other type of input device. Further, the computing system (1000) may include one or more output device(s) (1008), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (1000) may be connected to a network (1014) (e.g., a local area network (LAN), a wide area network (WAN) such as the Internet, mobile network, or any other type of network) via a network interface connection (not shown). The input and output device(s) may be locally or remotely (e.g., via the network (1012)) connected to the computer processor(s) (1002), memory (1004), and storage device(s) (1006). Many different types of computing systems exist, and the aforementioned input and output device(s) may take other forms.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments.

Further, one or more elements of the aforementioned computing system (1000) may be located at a remote location and connected to the other elements over a network (1014). Further, embodiments may be implemented on a distributed system having a plurality of nodes, where each portion may be located on a different node within the distributed system. In one embodiment, the node corresponds to a distinct computing device. The node may also correspond to a computer processor with associated physical memory. The node may also correspond to a computer processor or micro-core of a computer processor with shared memory and/or resources.

While augmenting an immediate first user task has been described with respect to a limited number of embodiments, those skilled in the art, having benefit of this disclosure, will appreciate that other embodiments can be devised which do not depart from the scope as disclosed herein. Accordingly, the scope should be limited by the attached claims.

What is claimed is:

1. A method for augmenting an immediate first user task, the method comprising:
obtaining a plurality of first role information identifying a role of a first user within an oilfield company, wherein the first user is performing oilfield operations in a field;
identifying a first current location of the first user in the field to identify the immediate first user task being performed by the first user in the field;
defining, using the plurality of first role information, a first user perspective of the first user;
selecting a plurality of first metadata corresponding to the first user perspective to obtain a first plurality of selected metadata; and
presenting the first plurality of selected metadata to the first user.

2. The method of claim 1, wherein presenting the plurality of first metadata comprises:
obtaining the oilfield output from a first viewpoint in the first current location of the first user;
encoding the oilfield output with the first plurality of selected metadata to obtain a first revised output; and
presenting the first revised output to the first user.

3. The method of claim 2, further comprising:
obtaining, after presenting the first revised output, an update, wherein the update comprises a second viewpoint in the first current location and a change to the first plurality of selected metadata, wherein the first viewpoint is different than the second viewpoint;
encoding the oilfield output with the update to obtain the first revised output; and
presenting the first revised output to the first user.

4. The method of claim 2, wherein encoding the oilfield output with the first plurality of selected metadata comprises overlaying the first plurality of selected metadata on the oilfield output.

5. The method of claim 2, wherein encoding the oilfield output with the first plurality of selected metadata comprises displaying the first plurality of selected metadata on the oilfield output, and wherein the displaying of the first plurality of selected metadata comprises color coding the first plurality of selected metadata.

6. The method of claim 2, wherein the oilfield output comprises a visual in a field of view visible from the first viewpoint of the first user.

7. The method of claim 1, wherein presenting the plurality of first metadata comprises an auditory alert and a vibratory alert.

8. The method of claim 1, further comprising:
obtaining a plurality of second role information identifying a role of a second user within the oilfield company, wherein the second user is performing oilfield operations in the field;
identifying a second current location of the second user in the field to identify an immediate second user task being performed by the second user in the oilfield management program, wherein the immediate first user task being performed by the first user is the same as the immediate second user task being performed by the second user, and wherein the first current location is the same as the second current location;
defining, using the plurality of second role information, a second user perspective of the second user;
selecting a plurality of second metadata corresponding to the second user perspective to obtain a second plurality of selected metadata;
obtaining the oilfield output from a second viewpoint in the second current location of the second user;
encoding the oilfield output with the second plurality of selected metadata to obtain a second revised output; and
presenting the second revised output to the second user.

9. The method of claim 1, wherein selecting the plurality of first metadata further comprises:
selecting a plurality of additional context filters corresponding to the first user perspective to obtain a plurality of selected context filters;
ranking the plurality of selected context filters to obtain a plurality of ranked context filters; and
applying the plurality of ranked context filters.

10. The method of claim 9, wherein selecting the plurality of additional context filters is based on the first user perspective of the first user, wherein the plurality of selected context filters comprises at least one selected from a group consisting of the first current location, schedule of the first user, historical trends of the immediate first user task, equipment of the immediate first user task, team information of the first user, and goals of the immediate first user task.

11. The method of claim 1, wherein the first plurality of selected metadata comprises predictive data and current data.

12. A system for augmenting an immediate first user task, the system comprising:
a computer processor; and
an oilfield application, executing on the computer processor, and comprising:
an oilfield management program configured to:
perform the immediate first user task with a first user, and
a sensory data manager configured to:
obtain a plurality of first role information identifying the role of the first user within an oilfield company, wherein the first user is performing oilfield operations in a field,
identifying a first current location of the first user in the field to identify the immediate first user task being performed by the first user in the oilfield management program;
define, using the plurality of first role information, a first user perspective of the first user,
select a plurality of first metadata corresponding to the first user perspective to obtain a first plurality of selected metadata,
obtain the oilfield output from a first viewpoint in the first current location of the first user, and
encode the oilfield output with the first plurality of selected metadata to obtain a first revised output.

13. The system of claim 12, further comprising:
a data repository configured to:
store a plurality of metadata comprising the plurality of first metadata.

14. The system of claim 13, further comprising:
a data collection system comprising:
a plurality of data collectors configured to:
collect the plurality of metadata from a plurality of information sources; and
store the plurality of metadata in the data repository.

15. The system of claim 14, further comprising:
a data aggregation system configured to:
aggregate the plurality of metadata collected by the data collection system to obtain a plurality of aggregated metadata; and
store the plurality of aggregated metadata in the data repository.

16. The system of claim 12, further comprising:
a computing device comprising:
a client application configured to:
query the first user for the plurality of first role information,
execute an instance of the oilfield application, and
present the first revised output to the first user; and
local data store configured to:
store the first role information, and
store the first plurality of selected metadata.

17. A non-transitory computer readable medium comprising instructions for augmenting an immediate first user task, the instructions when executed by a computer processor comprising functionality for:
obtaining a plurality of first role information identifying a role of a first user within an oilfield company, wherein the first user is performing oilfield operations in a field;
identifying a first current location of the first user in the field to identify the immediate first user task being performed by the first user in the oilfield management program;
defining, using the plurality of first role information, a first user perspective of the first user;
selecting a plurality of first metadata corresponding to the first user perspective to obtain a first plurality of selected metadata;
presenting the plurality of first metadata to the first user.

18. The non-transitory computer readable medium of claim 17, wherein presenting the plurality of first metadata comprises:
obtaining the oilfield output from a first viewpoint in the first current location of the first user;
encoding the oilfield output with the first plurality of selected metadata to obtain a first revised output; and
presenting the first revised output to the first user.

19. The non-transitory computer readable medium of claim 17, further comprising:
obtaining a plurality of second role information identifying a role of a second user within the oilfield company, wherein the second user is performing oilfield operations in the field;
identifying a second current location of the second user in the field to identify an immediate second user task being performed by the second user in the oilfield management program, wherein the immediate first user task being performed by the first user is the same as the immediate second user task being performed by the second user, and wherein the first current location is the same as the second current location;
defining, using the plurality of second role information, a second user perspective of the second user;
selecting a plurality of second metadata corresponding to the second user perspective to obtain a second plurality of selected metadata;
obtaining the oilfield output from a second viewpoint in the second current location of the second user;
encoding the oilfield output with the second plurality of selected metadata to obtain a second revised output; and
presenting the second revised output to the second user.

20. The non-transitory computer readable medium of claim 17, wherein selecting the plurality of first metadata further comprises:
selecting a plurality of additional context filters corresponding to the first user perspective to obtain a plurality of selected context filters;
ranking the plurality of selected context filters to obtain a plurality of ranked context filters; and
applying the plurality of ranked context filters.
